(19) United States
(12) Patent Application Publication
(10) Pub. No.: US 2015/0128425 A1
(43) Pub. Date: May 14, 2015

(54) Cable Prep Safety Tool

(71) Applicant: BAKER HUGHES INCORPORATED, Houston, TX (US)

(72) Inventors: Spencer L. Wilcox, Claremore, OK (US); Frank W. Eddings, Claremore, OK (US)

(73) Assignee: BAKER HUGHES INCORPORATED, Houston, TX (US)

(21) Appl. No.: 14/485,333

(22) Filed: Sep. 12, 2014

Related U.S. Application Data
(60) Provisional application No. 61/891,605, filed on Oct. 16, 2013.

(51) Int. Cl. H02G 1/12

(52) U.S. Cl. CPC H02G 1/1229
USPC 30/90.1

(57) ABSTRACT

A cable preparation tool for use in removing insulation from an insulated cable. The cable preparation tool includes a tool body, a blade and a number of cut guides that permit different types of cuts to be made by the tool.

### BACKGROUND OF THE INVENTION

1. Field of the Invention

The invention relates generally to devices and methods for ring cutting, scoring and penciling insulated and/or jacketed cables.

2. Description of the Related Art

Insulated or jacketed cables often need to be spliced with other components, prepared for assembly or repaired from a defect. To do this, the insulation must be cut or removed in order to prepare the cable. In many fields, safety concerns have brought about prohibitions on the use of open knives or blades to perform this work.

### SUMMARY OF THE INVENTION

This invention provides a cable preparation tool that is useful of forming annular ring cuts, axial scoring cuts and angled shave-type cuts in the insulation surrounding the conductor of a cable. In preferred embodiments, the cable preparation tool provides a cutting blade that is recessed so that chance of injury to workers is minimized.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is an isometric view of an exemplary cable preparation tool constructed in accordance with the present invention.

FIG. 2 is a front view of the exemplary cable preparation tool of FIG. 1.

FIG. 3 is a top view of the tool shown in FIGS. 1 and 2.

FIG. 4 is a transparent side view of portions of the tool shown in FIGS. 1-3.

FIG. 5 is a cross-sectional view taken along lines 5-5 in FIG. 4.

### DETAILED DESCRIPTION OF THE PREFERRED EMBODIMENTS

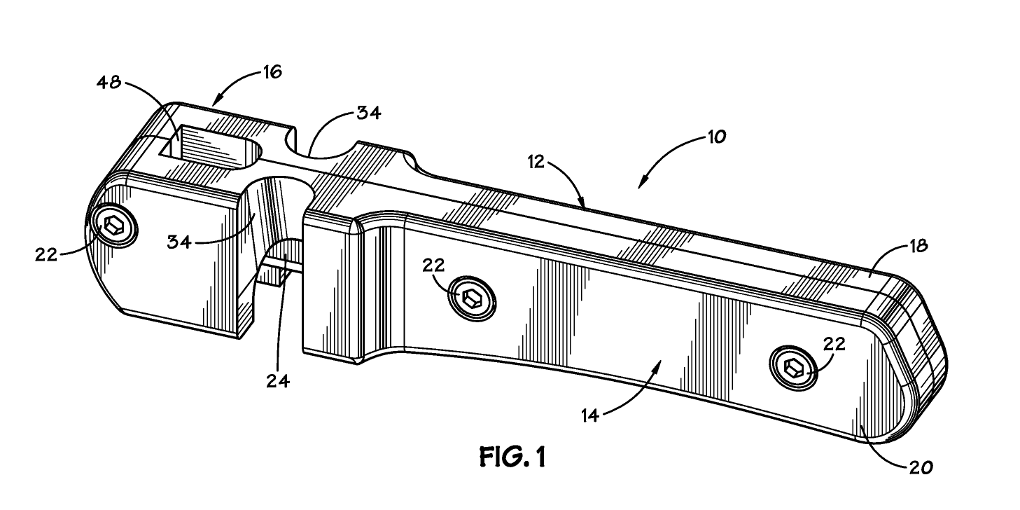

FIGS. 1-4 illustrate an exemplary cable preparation tool 10 in accordance with the present invention. The exemplary cable preparation tool 10 includes an elongated tool body 12 having a handle portion 14 by which the tool 10 can be easily gripped and manipulated. Opposite the handle portion 14 is a working end 16 which contains the blade member 24 and presents various guide grooves. In preferred embodiments, the tool body 12 is made up of separable body halves 18, 20 which are releasably secured to each other by connector screws 22. The tool body 12 has a longitudinal axis 23.

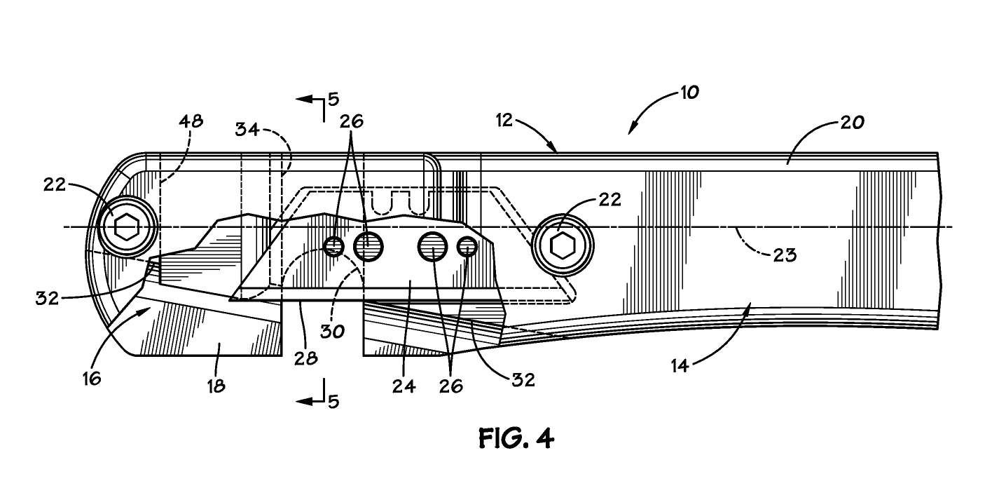

A blade member 24 (best seen in FIG. 4) is retained within the tool body 12 by retaining pins 26 and presents a cutting edge 28 that is recessed within the body 12.

A ring cut guide groove 30 (see FIG. 4) is formed within the lower portion of the tool body 12. The ring cut guide groove 30 is oriented transversely with respect to the longitudinal axis 23 of the tool body 12 and preferably has a generally semicircular cross-section that is shaped and sized to accept a desired cable. When a cable (not shown) is disposed within the ring cut guide groove 30, the cutting blade member 24 will make a radial cut within the insulation or jacketing of the cable. Using the handle 14, the tool body 12 can then be rotated about the circumference of the cable in order to make an annular cut through the insulation or jacketing.

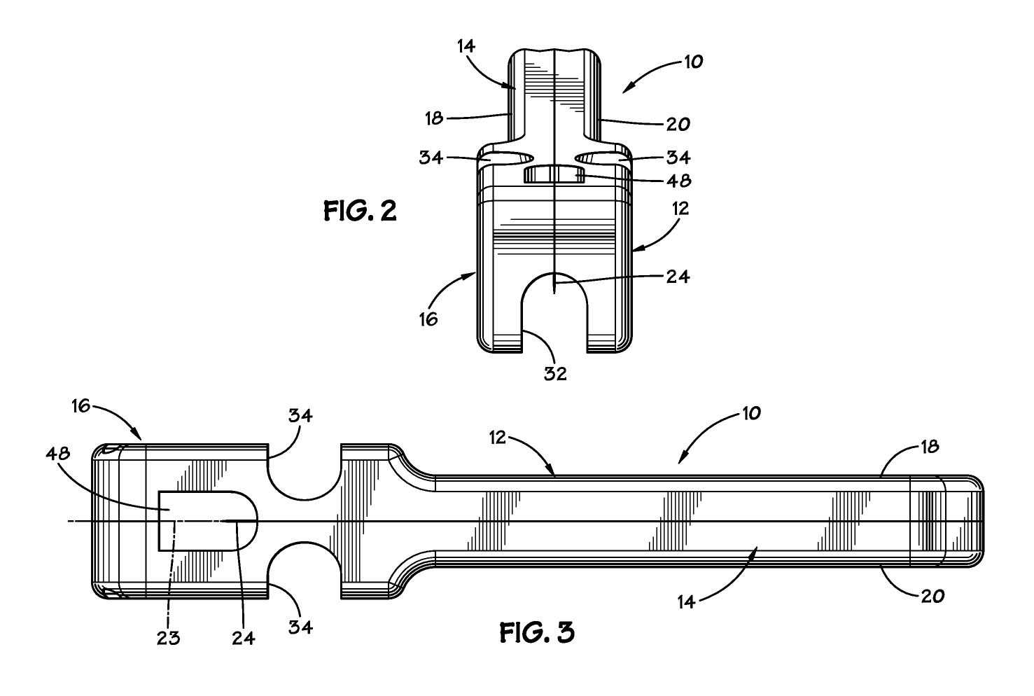

A scoring cut guide 32 is also formed within the lower portion of the tool body 12. The scoring cut guide 32 preferably has a generally semicircular cross-section (see FIG. 2) which is shaped and sized to receive a desired cable. As can be seen from reference to FIG. 4, the scoring cut guide 32 is preferably angled with respect to the axis 23 of the tool body 12. Drawing a cable along the scoring cut guide 32 will bring the cable into engagement with the cutting edge 28 of the blade member 24. This will create an axial cut along the cable through the insulation of the cable.

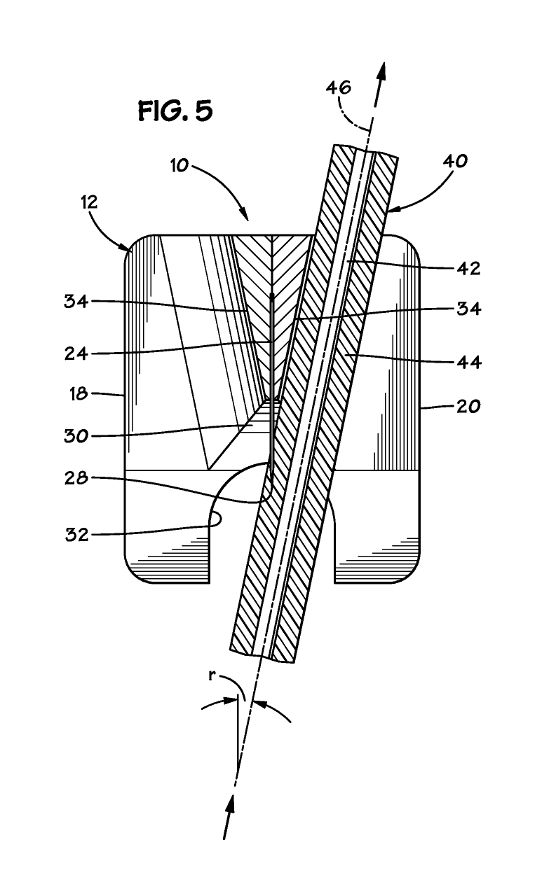

At least one penciling guide 34 is preferably formed within the tool body 12. In the depicted embodiment, there are two penciling guides 34—one on each lateral side of the tool body 12. The penciling guides 34 are angled inwardly from the top to the bottom of the tool body 12 so that an acute angle is formed with the blade 24. As a result, cable that is drawn through a penciling guide 34 is slit along the insulation by the blade member 24 at an angle to the central axis of the cable. FIG. 5 is a cross-sectional view taken along lines 5-5 in FIG. 4 and depicts cable 40 being drawn through a penciling guide 34. The cable 40 includes a central conductor 42 which is radially surrounded by insulation 44. As the cable 40 is drawn through the penciling guide 34 in the direction of arrow 46, the cutting edge 28 of the blade member 24 cuts into the insulation 44 at an angle “r” to the longitudinal axis 46 of the cable 40. In preferred embodiments, the angle “r” is an acute angle. This is a penciling cut which may be used to strip portions of the insulation 44 from the conductor 42.

In preferred embodiments, a viewing window 48 is formed within the upper surface of the tool body 12 so that a user can view a cable 40 that is disposed within the scoring cut guide 32. The viewing window 48 helps a user to ensure that the cutting edge 28 of the blade member 24 will engage the cable 40 at a desired location.

The inventors have found that the cable preparation tool 10 is effective to remove insulation and sheathing from a variety of cables 40 using ring cuts, scoring cuts and/or penciling cuts to remove and strip the insulation 44 away from the conductor 42.

Although the terms “cable” and “insulation” are specifically mentioned in the previous description, it should be understood that these terms should be interpreted broadly so as to apply to any type of linear conductor or conduit that is jacketed or coaxially surrounded by one of various forms of insulation or jacketing. The foregoing description is directed to particular embodiments of the present invention for the purpose of illustration and explanation. It will be apparent, however, to one skilled in the art that many modifications and changes to the embodiment set forth above are possible without departing from the scope and the spirit of the invention.

What is claimed is:

1. A cable preparation tool for removing insulation from an insulated cable, the tool comprising:
a tool body;
a blade member mounted on the tool body;
a ring cut guide groove formed within the tool body so that cable disposed within the ring cut guide groove will have a radial cut made within the insulation by the blade member;
a penciling cut guide formed within the tool body so that cable drawn along the penciling guide will have an angled penciling cut made by the blade member.

2. The cable preparation tool of claim 1 further comprising a scoring cut guide formed within the tool body such that cable drawn through the scoring cut guide will have an axial cut made by the blade member within the insulation.

3. The cable preparation tool of claim 2 further comprising a viewing window formed within the tool body to allow a user to view a cable disposed within the scoring cut guide.

4. The cable preparation tool of claim 1 wherein the penciling cut guide forms an acute angle with the blade member so that the blade will cut the insulation at an acute angle with respect to a longitudinal axis of the cable as the cable is drawn along the penciling cut guide.

5. The cable preparation tool of claim 1 wherein the tool body comprises a handle portion and a working end.

6. The cable preparation tool of claim 1 wherein the tool body comprises separable body halves which are releasably secured to each other by a connector screw.

7. A cable preparation tool for removing insulation from an insulated cable, the tool comprising:
a tool body;
a blade member mounted on the tool body;
a ring cut guide groove formed within the tool body so that cable disposed within the ring cut guide groove will have an angular cut made within the insulation by the blade member; and
a scoring cut guide formed within the tool body such that cable drawn through the scoring cut guide will have an axial cut made by the blade member within the insulation.

8. The cable preparation tool of claim 7 further comprising a penciling cut guide formed within the tool body so that cable drawn along the penciling guide will have an angled penciling cut made by the blade member.

9. The cable preparation tool of claim 7 further comprising a viewing window formed within the tool body to allow a user to view a cable disposed within the scoring cut guide.

10. The cable preparation tool of claim 8 wherein the penciling cut guide forms an acute angle with the blade member so that the blade will cut the insulation at an acute angle with respect to a longitudinal axis of the cable as the cable is drawn along the penciling cut guide.

11. The cable preparation tool of claim 7 wherein the tool body comprises a handle portion and a working end.

12. The cable preparation tool of claim 7 wherein the tool body comprises separable body halves which are releasably secured to each other by a connector screw.

13. A cable preparation tool for removing insulation from an insulated cable, the tool comprising:
a tool body;
a blade member mounted on the tool body;
a ring cut guide groove formed within the tool body so that cable disposed within the ring cut guide groove will have an angular cut made within the insulation by the blade member;
a scoring cut guide formed within the tool body such that cable drawn through the scoring cut guide will have an axial cut made by the blade member within the insulation; and
a penciling cut guide formed within the tool body so that cable drawn along the penciling guide will have an angled penciling cut made by the blade member.

14. The cable preparation tool of claim 13 further comprising a viewing window formed within the tool body to allow a user to view a cable disposed within the scoring cut guide.

15. The cable preparation tool of claim 13 wherein the penciling cut guide forms an acute angle with the blade member so that the blade will cut the insulation at an acute angle with respect to a longitudinal axis of the cable as the cable is drawn along the penciling cut guide.

16. The cable preparation tool of claim 13 wherein the tool body comprises a handle portion and a working end.

17. The cable preparation tool of claim 13 wherein the tool body comprises separable body halves which are releasably secured to each other by a connector screw.
